(19) United States
(12) Patent Application Publication
(10) Pub. No.: US 2011/0117292 A1
(43) Pub. Date: May 19, 2011

(54) METHODS FOR CONTROLLING COATING GLOSS

(76) Inventors: Shaobing Wu, Jamestown, NC (US); Frank Chen, Greensboro, NC (US); George Teng, Greensboro, NC (US)

(21) Appl. No.: 12/671,835

(22) PCT Filed: Jul. 11, 2008
(86) PCT No.: PCT/US08/08541

§ 371 Date: Jan. 14, 2011

Related U.S. Application Data
(60) Provisional application No. 60/959,418, filed on Jul. 13, 2007.

(51) Int. Cl. B05D 3/06; B05D 3/12

(52) U.S. Cl. 427/558; 427/355; 427/359; 118/641

(57) ABSTRACT

A method including applying a coating composition on a substrate to form a coating, wherein the coating has a first surface roughness; transferring a pattern to the coating to form a patterned coating, wherein the patterned coating has a second surface roughness different from the first surface roughness; and curing the patterned coating to form a cured coating with a desired level of gloss.

### TECHNICAL FIELD

The present disclosure relates to a method for imparting a specific level of gloss to a coating on an article.

### BACKGROUND

The final gloss of a coating, for example a 100% solids UV curable topcoat, depends on many parameters that can be difficult to control. For example, the properties of the coating solution itself, such as the resin binders used in the formulation, the formulation viscosity and the flatting pigment loading, can have an impact on the topcoat's final gloss level. In addition, cure conditions such as curing speed, temperature, oxygen inhibition and the like, have an impact on the gloss in the final coating product. To provide a topcoat with a very low gloss, the coating solution typically has a very high loading of matting pigment to create roughness on the surface of the cured coating. However, this high pigment loading may also reduce the flow properties of the coating solution.

Even conditions in the facility where the coating is applied, such as ambient temperature and humidity, can vary considerably from season-to-season and from one plant location to another. Further, variations in the performance of the coating equipment such as, for example, conveyor speed and/or the UV dosage emitted by a lamp used for curing the coating, can impact the final gloss level.

Changing the gloss level of a coating during production may require stopping the finishing line and flushing out the coating solution. The roller coating station must then be filled with a new coating solution with the desired pigment loading level before re-starting the finishing line. The coating weight must then be re-adjusted before production resumes. This process is time consuming and expensive, and requires maintaining an inventory of coating solutions with differing pigment loadings and differing gloss levels.

### SUMMARY

In general, the present disclosure is directed to a method for imparting a pattern in a coating to provide the coating with a desired level of gloss. A coating composition is initially applied on a substrate to form a coating with a first surface roughness. A pattern and/or texture are then transferred to the coating to form a patterned coating. Following the patterning step, the patterned coating has a second level of surface roughness. When the patterned coating is fully cured, the second level of surface roughness imparts to the cured patterned coating a desired level of gloss.

In one aspect, the present disclosure is directed to a method including applying a coating composition on a substrate to form a coating, wherein the coating has a first surface roughness; transferring a pattern to the coating to form a patterned coating, wherein the patterned coating has a desired second surface roughness; and curing the patterned coating to form a cured coating with a desired level of gloss.

In another aspect, the present disclosure is directed to a method including: providing a coating composition on a substrate; at least partially curing the coating composition to form a partially cured coating composition; contacting a surface of the partially cured coating composition with a patterned device to form a pattern therein; and fully curing the coating composition to form a textured coating, wherein the pattern provides the textured coating with a predetermined level of gloss.

In yet another aspect, the present disclosure is directed to a method including: applying a thermosetting coating composition on a substrate; partially UV curing the coating composition to form a B-stage coating; contacting the B-stage coating with a textured article selected from rollers, films or stamps to form a textured B-stage coating; and fully UV curing the textured B-stage coating composition to form a textured coating, wherein the textured coating has a predetermined level of gloss.

In yet another aspect, the present disclosure is directed to a method including: applying a thermosetting coating composition on a substrate; applying a textured polymeric film on the coating composition; partially UV curing the coating composition through the film to form a textured B-stage coating; and fully UV curing the textured B-stage coating composition to form a textured coating, wherein the textured coating has a predetermined level of gloss.

In yet another embodiment, the present disclosure is directed to a system including: a UV-curable coating composition; and at least one of a film or a roller with a textured surface, wherein the textured surface is selected such that when the surface contacts the coating composition, a pattern is transferred from the surface to the coating composition to provide the coating composition with a predetermined level of gloss.

The presently described process has a number of advantages. The final gloss of the coating does not entirely depend on properties of the coating solution such as, for example, the formulation viscosity, the loading level of the matting agents and the curing conditions such as the UV dosage, the curing rate, or the temperature. Since gloss control does not depend entirely on the loading of matting agent, the flow properties of the coating solution are greatly improved, and the finished coating can be made with very low gloss and excellent clarity.

In production, one coating formulation may be used for all desired gloss levels and surface texture variations. Further, changing gloss levels during production is greatly simplified, which enhances plant output and decreases overall production costs. For example, changing gloss levels may be as simple as changing from a first patterned roller or film to a different patterned roller or film. A roller or film change does not require stopping the production line to clean and refill production equipment, and re-adjustment of the coating weight of the coating solution is not required for each gloss change.

The details of one or more embodiments of the invention are set forth in the accompanying description below. Other features, objects, and advantages of the invention will be apparent from the description, and from the claims.

### DETAILED DESCRIPTION

In general, the present disclosure is directed to a process for transferring an image to a coating to provide the coating with a desired level of gloss.

In this method a coating composition is initially applied on a substrate to form a coating. The coating composition can be formulated as a stain, a primer, a sealer, a topcoat and the like to finish a substrate (e.g. wood, plastic or metal). For example, the presently described method is suited for coatings applied to wood flooring, vinyl flooring, metal panels and the like.

The coating composition may be applied to a substrate by any conventional method, and suitable methods include spraying, brushing, dip coating, sheet coating, coil coating, roll coating, and the like.

The coating composition applied to the substrate may be any thermosetting or energy curable coating. Suitable coating compositions include, for example, two component isocyanates, two component epoxies, unsaturated polyesters and peroxide initiated polyesters. Ultraviolet (UV) curable coatings are preferred.

By way of example, a typical UV curable coating composition includes about 5 to about 60 wt % acrylate monomers, about 5 to about 50 wt % polyester, polyether or epoxy acrylate oligomers, about 1 to about 5 wt % photoinitiators, about 0.5 to about 5 wt % coating additives, and about 0 to about 10 wt % pigments or colorants.

The thickness of the coating may vary widely depending on the performance requirements and the properties of the underlying substrate, as well as on the formulation of the coating composition. However, for a wood substrate such a plank intended for use as flooring, the coating should preferably have a thickness of about 1 to about 3 mils (0.025 to 0.075 mm).

The coating as applied to the substrate has a first surface roughness. The surface roughness of the coating may be controlled by controlling the surface roughness of the underlying substrate, and/or by controlling the formulation of the coating composition itself. As is well known, the surface roughness of the as-applied coating can optionally be adjusted for a particular application by incorporating matting agents and flatting pigments. These materials, typically silica-based materials, create surface roughness in the applied coating and lower its overall gloss level.

After the coating is applied on the substrate, a texture or pattern is transferred to the coating. The methods of transfer may vary widely, but typically the coating is contacted with a textured article, which results in the physical transfer of a pattern from the textured article to the coating to form a patterned coating. The texture imparted to the coating provides the patterned coating with a second level of surface roughness that is different from the first level of surface roughness in the coating as initially applied on the substrate.

The pattern may be formed by contacting the coating with any material that imparts roughness to the coating. Examples include patterned or textured articles such as rollers, patterned metal or polymeric films, stamps, and combinations thereof.

For example, the pattern may be formed in the coating by contacting an exposed surface of the coating with a textured film or a textured roller. The texture on the film or roller is then physically transferred to the exposed surface of the coating.

To enhance the consistency of the transfer process, the surface of the film or roller that contacts the coating may optionally be made of or coated with a non-stick material. If a roller is used, a rubber roller has been found to provide very effective image transfer.

Any pattern may be transferred to the coating, and the pattern may be regular or random, continuous or discontinuous. The pattern may be applied to all or a part of the coating, although for uniform gloss control full coverage is preferred. Suitable patterns include, but are not limited to, for example, random “cracked” surfaces, reptilian (“snake” or “alligator” skin) patterns, checkerboard patterns and the like.

In production, use of a roller may have certain advantages when transferring the pattern to the coating. With a roller, changing the pattern in the coating is as simple as replacing a roller having a first pattern with another roller with a different pattern. For example, if the roller is supported on a fiberglass core, air pressure may be used to detach the roller core from its metal support shaft, and a new roller may simply slide into place on the metal shaft.

When the pattern is transferred, the coating should be in a state such that the image is accurately and reliably accepted on the coating surface. Depending on coating chemistry and the characteristics of the underlying substrate, the pattern may be transferred to the coating as initially applied. For example, once the coating is applied to the substrate, the textured polymeric film may be applied directly on the wet coating layer, or the wet coating layer may be contacted with the textured roller.

However, at the time of transfer, the coating is preferably partially cured such that the pattern or texture will be more accurately and consistently accepted and maintained in the coating. The coating may be partially cured by any technique, such as heating the substrate and/or the coating, or by exposing the coating to light of a specified wavelength. If a textured polymeric film is used for image transfer, the coating may be partially cured through the film after the film is applied to the substrate, or partial cure may take place before the film is applied on the coating layer.

For the preferred thermosetting coatings used in the presently described process, the coating should be UV curable and the cure should be controlled at a B-stage. As used herein, B-stage refers to a coating that has reacted beyond the stage of initial application (A-stage) so that the coating has only partial solubility in common solvents such as, for example, alcohols and ketones, and has a tacky surface capable of accepting any physical images and surface roughness under pressure.

For the UV coatings preferred for use in the presently described process, a B-stage resin is typically formed by exposing the A-stage coating to some combination of UVA, UVB, UVC and UV visible light. In the present application, UVA refers to light having a wavelength of about 320 nm to about 390 nm, UVB refers to wavelengths of about 280 nm to about 320 nm, UVC refers to wavelengths of about 100 nm to about 280 nm, and UVV (visible) refers to wavelengths of about 390 nm to about 440 nm.

The light applied to the coating on the substrate may be characterized by the UV dose (mJ/cm²), which in this application refers to the total amount of energy arriving at the surface per unit area per unit time. The light applied to the substrate may also be characterized by the UV energy (mW/cm²), which in this application refers to the radiant power arriving at the surface of the coating per unit area. The UV energy is more characteristic of lamp geometry, and is also referred to as peak irradiance.

The light energy required to form a B-stage coating depends on the formulation of the A-stage coating, the thickness of the applied A-stage coating, temperature, humidity and the like. However, as an example, for typical thermosetting resins on wood substrates, to form a B-stage resin the A-stage resin is exposed to a total UV dose (UVA+UVB+UVC+UVV) of about 200 to 400 (mJ/cm²) and a total UV energy (UVA+UVB+UVC+UVV) of about 300 to 500 (mW/cm²).

Following transfer of the pattern to the coating to form the patterned coating, the patterned coating is further cured to form a fully cured coating. In the example above, the B-staged patterned coating is further cured to form a C-staged coating, which in this application refers to a thermosetting coating that is fully crosslinked and substantially infusible and insoluble in most common solvents. Again, the conditions used to C-stage the patterned coating depend on the formulation of the B-stage resin, the thickness of the B-stage resin, temperature, humidity and the like. However, the C-stage curing conditions should be carefully selected to at least substantially preserve, and preferably fully preserve, the pattern and/or texture in the patterned coating.

As an example, for typical UV curable coating on wood substrates, to form a C-stage film the B-stage resin is exposed to a total UV dose (UVA+UVB+UVC+UVV) of about 1000 to about 3000 (mJ/cm²) and a UV energy (UVA+UVB+UVC+UVV) of about 1000 to about 4000 (mW/cm²).

If a textured polymeric film is used for image transfer, following full cure the film may optionally be removed from the surface of the article, or the film may remain in place on the article for subsequent removal by the user.

When the patterned coating is fully cured to form the C-staged cured coating, the second level of surface roughness imparts to the cured coating a desired or a predetermined level of gloss. Gloss may be measured using any technique known in the art, but is typically measured with a portable or micro gloss meter available from Byk Gardner, Columbia, Md.

### EXAMPLES

### Example 1

A 100% solids sprayable UV curable coating composition was formulated according to Table 1. The coating was prepared by adding the ingredients under agitation (500 to 1000 RPM) in the order as indicated in the table. The final coating was filtered through a 10 μm screen and stored in a metal can for spray application. The formula was applied with a conventional air gun from Binks Inc., on a flat oak plank suitable for flooring. The resulting coating was about 2 mils (0.05 mm) thick. The coated plank was introduced into a slow-cure UV curing unit, and the conditions in Table 2 below were applied to form a B-stage coating.

TABLE 1

| 100 wt % Sprayable UV Coating Composition | |
|---|---|
| SR 306 | 40 |
| SR 351 | 8 |
| SR 256 | 6 |
| CN2262 | 38.9 |
| LUCIRIN TPO | 1.0 |
| DAROCURE MBF | 1.0 |
| DAROCURE 1173 | 2.0 |
| DISPERBYK-163 | 1 |
| DOW CORNING 11 Additive | 1.3 |
| BYK-411 | 0.8 |
| Total | 100 |

SR 306 is tripropylene glycol diacrylate (TPGDA) available from Sartomer Corp., Exton, PA
SR 351 is EBECRYL trimethylolpropane triacrylate (TMPTA) available from Sartomer Corp.
SR 256 is 2-Ethoxyethoxy ethyl acrylate (EOEOEA) available from Sartomer Corp.
CN 2262 is a polyester acrylate available from Sartomer Corp.
LUCIRIN TPO is a photoinitator available from BASF Corp., Florham Park, NJ
DAROCURE MBF is a photoinitiator available from Ciba Specialty Chemicals, Tarrytown, NY
DAROCURE 1173 is a photoinitiator available from Ciba Specialty Chemicals, Tarrytown, NY
DISPERBYK-163 and BYK 411 are dispersing aids available from Byk Chemie, Wesel, Germany
DOW CORNING 11 ADDITIVE is a dispersing aid available from Dow Corning Corp., Midland, MI

TABLE 2
B-Stage Curing Conditions

| Wavelength | UV Dose (mJ/cm²) | UV Energy (mW/cm²) |
|---|---|---|
| UVA | 145 | 156 |
| UVB | 121 | 123 |
| UVC | 15 | 18 |
| UVV | 62 | 62 |
| | 343 (Total) | 359 (Total) |

The B-staged coating was then imprinted by hand with a non-stick rubber roller having an alligator skin-like textured finish to form patterned coating, which was immediately introduced into a fast cure UV curing unit and fully cured under the conditions shown below in Table 3.

TABLE 3
C-Stage Curing Conditions

| | | UV Energy |
|---|---|---|
| Wavelength | UV Dose (mJ/cm²) | (mW/cm²) |
| UVA | 810 | 379 |
| UVB | 676 | 317 |
| UVC | 94 | 45 |
| UVV | 161 | 346 |
| | 1741 (Total) | 1087 (Total) |

The resulting fully cured coating had a gloss level of 10 sheens as measured with a Byk Garner micro gloss meter, and the alligator skin-like texture was preserved.

### Example 2

A low viscosity 100% solids sprayable UV curable coating composition was formulated according to Table 4. The coating was prepared by adding the ingredients under agitation (500 to 1000 RPM) in the order as indicated in the table. The final coating was filtered through a 10 μm screen and stored in a metal can for spray application. The formula was applied with a conventional air gun from Binks Inc. on a flat oak plank suitable for flooring. The resulting coating was about 1 mil (0.025 mm) thick. The coated plank was introduced into a slow-cure UV curing unit, and the conditions in Table 2 above were applied to form a B-stage coating.

TABLE 4
100 wt % Sprayable UV Coating Composition

| | |
|---|---|
| SR 306 | 50 |
| SR 351 | 8 |
| SR 256 | 7 |
| CN2262 | 28.9 |
| LUCIRIN TPO | 1.0 |
| GENOCURE MBF | 1 |
| DAROCUR 1173 | 1.0 |
| DISPERBYK-163 | 1 |
| DOW CORNING 11 | 1.3 |
| BYK-411 | 0.8 |
| Total | 100 |

The B-staged coating was then imprinted by hand with a non-stick rubber roller having an alligator skin-like textured finish to form a patterned coating, which was immediately introduced into a fast cure UV curing unit and fully cured under the conditions shown below in Table 5.

TABLE 5
C-Stage Curing Conditions

| Wavelength | UV Dose (mJ/cm²) | UV Energy (mW/cm²) |
|---|---|---|
| UVA | 1126 | 939 |
| UVB | 928 | 809 |
| UVC | 146 | 131 |
| UVV | 500 | 435 |
| | 2700 (Total) | 2314 (Total) |

The resulting fully cured coating had a gloss level of 10 sheens as measured by a Byk Gardener Micro gloss meter, and the alligator skin-like texture was preserved.

### Example 3

The 100% solids sprayable UV curable coating composition of Table 1 was B-staged under the conditions of Table 2. The high, medium and low gloss textured polymeric films described in Table 6 below were then applied on an exposed surface of the B-staged coating and subsequently introduced into an UV oven. The texture from the films was physically transferred to the B-staged coating, which was then fully cured according to the conditions in Table 3 above.

The impact of the film application on the surface texture of the coating is also shown in Table 6. All measurements were made using a white light interferometer (Veeco NT2000) and a portable micro gloss meter from Byk Gardner at 60*. These data illustrate that the application of a film with desired texture or gloss can be used to control the surface roughness and the gloss of a B-staged coating, and this change in roughness and gloss is preserved in the fully cured coating.

TABLE 6
Gloss and Roughness

| | Gloss at | Average |
|---|---|---|
| Samples | 60° | Roughness (nm) |
| High Gloss Plastic Film Substrate | 88.7 | 13.7 |
| Copied Coating Film from | 86.5 | 17.3 |
| High Gloss Plastic Film Substrate | | |
| Medium Low Gloss Plastic Substrate | 39.3 | 117.9 |
| Copied Coating Film from Medium | 37.2 | 137.8 |
| Low Gloss Plastic Substrate | | |
| Low Gloss Plastic Substrate | 9.2 | 362.9 |
| Copied Coating Film from | 7.8 | 408.2 |
| Low Gloss Plastic Substrate | | |

Various embodiments of the invention have been described. These and other embodiments are within the scope of the following claims.

1. A method comprising:
applying a coating composition on a substrate to form a coating, wherein the coating has a first surface roughness;
transferring a pattern to the coating to form a patterned coating, wherein the patterned coating has a second surface roughness different from the first surface roughness; and
curing the patterned coating to form a cured coating with a desired level of gloss.

2. The method of claim 1, wherein the coating composition is partially cured, prior to transfer of the pattern, to form a partially cured coating.

3. The method of claim 2, wherein the pattern is transferred by physically contacting a surface of the partially cured coating with a patterned device.

4. The method of claim 3, wherein the patterned device comprises at least one of a textured roller, a textured film, and a textured stamp.

5. The method of claim 4, wherein the patterned device imparts to the partially cured coating a pattern selected from random patterns, regular patterns or combinations thereof.

6. The method of claim 5, wherein the pattern is a regular pattern.

7. The method of claim 6, wherein the regular pattern comprises at least one of alligator skin-like, snake skin-like or cracked patterns.

8. The method of claim 4, wherein the roller is a rubber roller.

9. The method of claim 8, wherein a surface of the rubber roller has a non-stick finish.

10. The method of claim 1, wherein the coating is UV curable.

11. The method of claim 10, wherein the coating is partially cured by exposing the coating to a UV dose sufficient to achieve a “B” stage.

12. The method of claim 4, wherein the patterned device is a textured film.

13. A method comprising:
providing a coating composition on a substrate;
at least partially curing the coating composition to form a partially cured coating composition;
contacting a surface of the partially cured coating composition with a patterned device to form a pattern therein; and
fully curing the coating composition to form a textured coating, wherein the pattern provides the textured coating with a predetermined level of gloss.

14. The method of claim 13, wherein the patterned device is selected from textured rollers, a textured films, textured stamps or combinations thereof.

15. The method of claim 14, wherein a surface of the patterned device has a non-stick finish.

16. The method of claim 14, wherein the roller is a rubber roller.

17. The method of claim 13, wherein the coating composition is UV curable.

18. The method of claim 17, wherein the coating composition is partially cured by exposing the coating composition to a UV dose of 200 to 400 mJ/cm² and a total peak irradiance of 300 to 500. mW/cm².

19. The method of claim 17, wherein the coating composition is fully cured by exposing the coating composition to a UV dose of 1000 to 3000 mJ/cm² and a total peak irradiance of 1000 to 4000. mW/cm².

20. The method of claim 14, wherein the surface texture on the roller comprises at least one of alligator skin-like, snake skin-like and cracked.

21. A method comprising:
applying a thermosetting coating composition on a substrate;
partially UV curing the coating composition to form a B-stage coating;
contacting the B-stage coating with a textured article selected from rollers, films or stamps to form a textured B-stage coating; and
fully UV curing the textured B-stage coating composition to form a textured coating, wherein the textured coating has a predetermined level of gloss.

22. The method of claim 21, wherein the textured article is a roller with a non-stick finish.

23. The method of claim 22, wherein the roller is a rubber roller.

24. The method of claim 21, wherein the partial curing conditions comprise exposing the coating composition to a UV dose of 200 to 400 mJ/cm² and a total peak irradiance of 300-500 mW/cm².

25. The method of claim 21, wherein the coating composition is fully cured by exposing the coating composition to a UV dose of 1000 to 3000 mJ/cm² and a total peak irradiance of 1000-4000. mW/cm².

26. The method of claim 21, wherein the surface texture on the roller is selected from alligator skin-like, snake skin-like or cracked.

27. A system comprising:
a UV-curable coating composition; and
at least one of a film or a roller with a textured surface, wherein the textured surface is selected such that when the surface contacts the coating composition, a pattern is transferred from the surface to the coating composition to provide the coating composition with a predetermined level of gloss.

28. A method comprising:
applying a thermosetting coating composition on a substrate;
applying a textured polymeric film on the coating composition;
partially UV curing the coating composition through the film to form a textured B-stage coating; and
fully UV curing the textured B-stage coating composition to form a textured coating, wherein the textured coating has a predetermined level of gloss.

29. The method of claim 28, wherein the film is removed from the textured B-stage coating prior to fully UV curing the textured B-stage coating.
